(19) United States
(12) Patent Application Publication
(10) Pub. No.: US 2009/0166323 A1
(43) Pub. Date: Jul. 2, 2009

(54) METHOD OF MANUFACTURING MAGNETIC RECORDING MEDIUM

(75) Inventors: Satoshi Shirotori, Yokohama-shi (JP); Yoshiyuki Kamata, Tokyo (JP); Kaori Kimura, Tokyo (JP); Masatoshi Sakurai, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/400,288

(22) Filed: Mar. 9, 2009

Related U.S. Application Data
(63) Continuation of application No. PCT/JP2008/061688, filed on Jun. 20, 2008.

(30) Foreign Application Priority Data
Jun. 28, 2007 (JP) 2007-171076

(51) Int. Cl. B44C 1/22

(52) U.S. Cl. 216/22

(57) ABSTRACT

According to one embodiment, a method of manufacturing a magnetic recording medium includes depositing a magnetic recording layer and a sacrifice layer on a substrate, patterning the sacrifice layer and magnetic recording layer to form protruded magnetic patterns and sacrifice patterns, depositing a nonmagnetic material in recesses between the magnetic patterns and sacrifice patterns and on the sacrifice patterns, and etching back the nonmagnetic material.

### CROSS-REFERENCE TO RELATED APPLICATIONS

This is a Continuation Application of PCT Application No. PCT/JP2008/061688, filed Jun. 20, 2008, which was published under PCT Article 21 (2) in English.

This application is based upon and claims the benefit of priority from Japanese Patent Application No. 2007-171076, filed Jun. 28, 2007, the entire contents of which are incorporated herein by reference.

### BACKGROUND

1. Field

One embodiment of the present invention relates to a method of manufacturing a magnetic recording medium.

2. Description of the Related Art

In recent years, for magnetic recording media incorporated into hard disk drives (HDDs), there have been tangible problems that improvement in track density is hindered by interference between neighboring tracks. Particularly, to reduce write blurring caused by fringe effect of a magnetic field from a write head is an important problem.

To deal with such a problem, a discrete track-type patterned medium (DTR medium) is proposed in which recording tracks are physically separated. In the DTR medium, the side erase phenomenon that the information of an adjacent track is erased when information is recorded and the side read phenomenon that the information of an adjacent track is read out when information is reproduced can be reduced, making it possible to improve the track density. Therefore, the DTR medium is expected to be a magnetic recording medium capable of providing a high recording density.

In order to perform read and write of the DTR medium with a flying head, it is preferable to flatten the surface of the DTR medium. Specifically, in order to separate neighboring tracks completely, for example, a protective layer with a thickness of about 4 nm and a magnetic recording layer with a thickness of about 20 nm are removed to form recesses with a depth of about 24 nm, thereby forming magnetic patterns. In the meantime, if deep recesses remain, head flying is not stabilized because the designed value of flying height for a flying head is about 10 nm. For this, the recesses between the magnetic patterns are filled with a nonmagnetic material to flatten the surface of the medium, thereby to ensure flying stability of the head.

The following method is proposed to provide a DTR medium having a flat surface by filling the recesses between the magnetic patterns with a nonmagnetic material. For example, a method of manufacturing a DTR medium having a flat surface is known in which the recesses between the magnetic patterns are filled with a nonmagnetic material by two-stage bias sputtering processes (see Japanese Patent No. 3,686,067). However, it is required to provide a cooling mechanism on the back surface of the substrate in bias sputtering, making it difficult to perform simultaneous processing of both surfaces.

Thus, in order to flatten the surface of a DTR medium, there is proposed a method of depositing a nonmagnetic material in the recesses between the magnetic patterns and on the magnetic patterns and etching back the nonmagnetic material. In the etch-back process, side etching of the nonmagnetic material on the magnetic patterns is utilized. However, the flattening effect through the side etching is small in areas where the width of the magnetic patterns is large, for example, address sections on the outer peripheral side, and therefore, it is necessary to repeat deposition of a nonmagnetic material and etch-back of the nonmagnetic material many times.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a plan view of a DTR medium according to an embodiment of the present invention along the circumferential direction;

FIGS. 2A to 2I are sectional views showing a method of manufacturing a DTR medium according to an embodiment of the present invention; and

FIGS. 3A to 3C are sectional views showing the process of FIG. 2H in more detail.

### DETAILED DESCRIPTION

Various embodiments according to the invention will be described hereinafter with reference to the accompanying drawings. In general, according to one embodiment of the invention, there is provided a method of manufacturing a magnetic recording medium, comprising: depositing a magnetic recording layer and a sacrifice layer on a substrate; patterning the sacrifice layer and magnetic recording layer to form protruded magnetic patterns and sacrifice patterns; depositing a nonmagnetic material in recesses between the magnetic patterns and sacrifice patterns and on the sacrifice patterns; and etching back the nonmagnetic material.

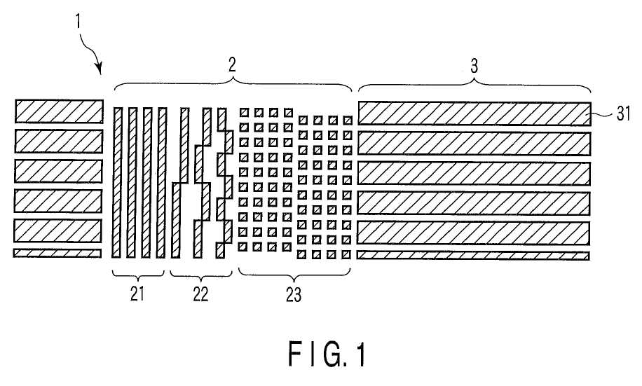

FIG. 1 shows a plan view of a DTR medium according to an embodiment of the present invention along the circumferential direction. As shown in FIG. 1, servo zones 2 and data zones 3 are alternately formed along the circumferential direction of the DTR medium 1. The servo zone 2 includes a preamble section 21, an address section 22 and a burst section 23. The data zone 3 includes discrete tracks 31.

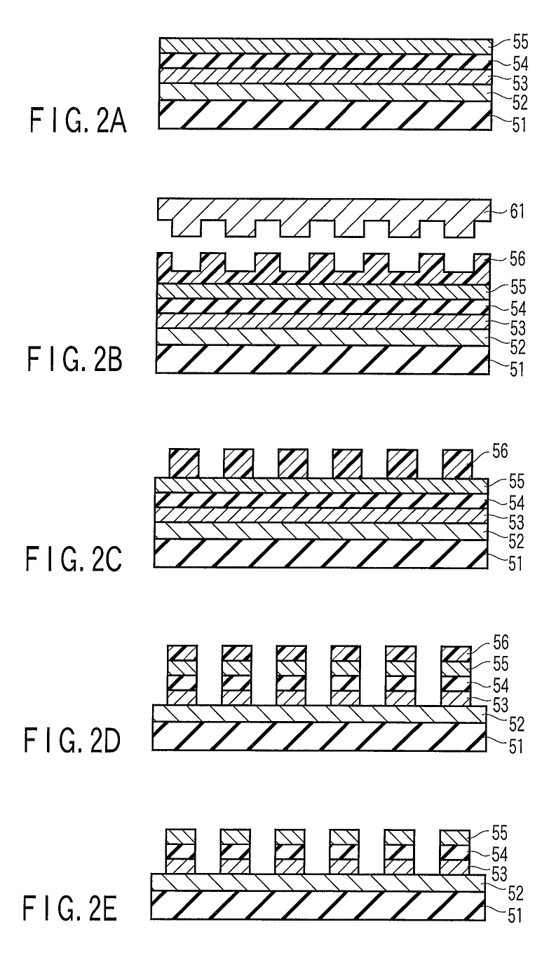

A method of manufacturing a DTR medium according to the embodiment of the present invention will be described with reference to FIGS. 2A to 2I. Here, the case of carrying out processing on one surface of the substrate is shown for the sake of illustrative simplification.

On a glass substrate 51, a soft magnetic underlayer 52 made of CoZrNb with a thickness of 120 nm, an underlayer for orientation control (not shown) made of Ru with a thickness of 20 nm, a magnetic recording layer 53 made of CoCrPt—SiO₂ with a thickness of 20 nm, a protective layer 54 made of carbon (DLC) with a thickness of 4 nm and a sacrifice layer 55 formed of, for example, Ru are successively deposited (FIG. 2A).

The material of the sacrifice layer 55 may not be particularly limited as long as it has a higher etching rate than a nonmagnetic material to be filled into the recesses between patterns as described later. Though the etching rates of the sacrifice layer and the nonmagnetic material vary depending on milling angle, the etching rate of the sacrifice layer is preferably higher than that of the nonmagnetic material when ions are incident normally in view of throughput. The material of the sacrifice layer includes: a metal material such as Ru, Ni, Al, W, Cr, Cu, Pt and Pd; an oxide such as SiO₂, TiOₓ and Al₂O₃; a nitride such as Si₃N₄, AlN and TiN; a carbide such as TiC; a borate such as BN; and a simple substance such as C and Si. The sacrifice layer is preferably of a material the etching end point of which can be easily detected by SIMS (secondary ion mass spectrometer) or Q-MASS (quadrupole mass spectrometer). With an increase in the thickness of the sacrifice layer, the depth of the recesses, before the nonmagnetic material is filled, is increased. Thus, the thickness of the sacrifice layer is preferably 3 nm or more and 20 nm or less.

A spin-on-glass (SOG) with a thickness of 100 nm as a resist 56 is applied to the sacrifice layer 55 by spin-coating. A stumper 61 is arranged so as to face the resist 54. On the stumper 61, patterns of protrusions and recesses inverse to those of the magnetic patterns shown in FIG. 1 are formed. The stamper 61 is used to perform imprinting, thereby forming the protrusions of the resist 56 corresponding to the recesses of the stamper 61 (FIG. 2B).

Etching is performed with an ICP (inductive coupling plasma) etching apparatus to remove resist residues left on bottoms of the recesses of the patterned resist 56. The conditions in the process are as follows: for instance, CF₄ is used as the process gas, the chamber pressure is 2 mTorr, the coil RF power of and the platen RF power are 100 W, respectively, and the etching time is 30 seconds (FIG. 2C).

Using the resist patterns (SOG) left unremoved as etching masks, ion milling is performed with an ECR (electron cyclotron resonance) ion gun to etch the sacrifice layer 55, the protective layer 54 and the magnetic recording layer 53 (FIG. 2D). The conditions in the process are as follows: for instance, Ar is used as the process gas, the microwave power is 800 W, the acceleration voltage is 500 V and the etching time is 3 minutes.

Then, the resist pattern (SOG) is stripped with a RIE apparatus (FIG. 2E). The conditions in the process are as follows: for instance, CF₄ gas is used as the process gas, the chamber pressure is 100 mTorr and the power is 100 W.

Next, a nonmagnetic material 57 made of NiNbTi is deposited by DC sputtering in such a manner as to be filled in the recesses between the stacks of magnetic and sacrifice patterns and to be stacked on the sacrifice patterns (FIG. 2F). In the process, a NiNbTi target is sputtered by DC sputtering under conditions of Ar flow rate of 100 sccm and a chamber pressure of 0.5 Pa to deposit a film with a thickness of 50 nm. The thickness of the nonmagnetic material 57 is preferably 30 to 100 nm. The thickness of the nonmagnetic material smaller than the depth of the recesses is undesirable because there is a risk that the subsequent etch-back process gives damage to the magnetic recording layer. In this stage, as shown in FIG. 2F, the surface is not flattened and the depth of the recesses is made about 20 nm. However, the width of the patterns is narrowed. The etching rate of the nonmagnetic material 57 is higher than those of the protective layer 54 and magnetic recording layer 53.

Then, the nonmagnetic material 57 is etched back (FIG. 2G). The conditions in the process are as follows: an ECR ion gun is used, the microwave power is set to 800 W and the acceleration voltage is set to 500 V, and Ar ions are applied for 3 minutes. These conditions are those for etching 20 nm of the nonmagnetic material 57 of NiNbTi. As a result, the depth of the recesses on the surface of the track region is reduced to 10 nm. The surface roughness of the medium is reduced and the depth of the recesses is reduced by half through this process. Because this process is to reform the surface of the nonmagnetic material, the conditions of the ECR ion gun, such as a process time, are parameters not so important. With an increase in ion radiation time, the effect of reducing the surface roughness of the nonmagnetic material and the effect of reducing the depth of the recesses are increased. It is however necessary to make the nonmagnetic material thicker in the process of filling the nonmagnetic material 55 (FIG. 2F).

If the foregoing deposition and etch-back of the nonmagnetic material are repeated, a DTR medium having a flat surface can be provided. However, it takes a long time to flatten the surface of address sections on the outer peripheral side where protruded patterns with a large width are formed, making it difficult to accomplish the flattening. It is therefore necessary to repeat many times the deposition and etch-back of the nonmagnetic material in a case where the sacrifice layer 55 is not used.

In the embodiment of the present invention, when etch-back is further continued in a state that the surface of the sacrifice layer 55 is exposed, side etching of the protruded sacrifice patterns proceeds faster and the irregularities of the surface decrease because the sacrifice layer 55 has a higher etching rate than the nonmagnetic material 57 (FIG. 2H).

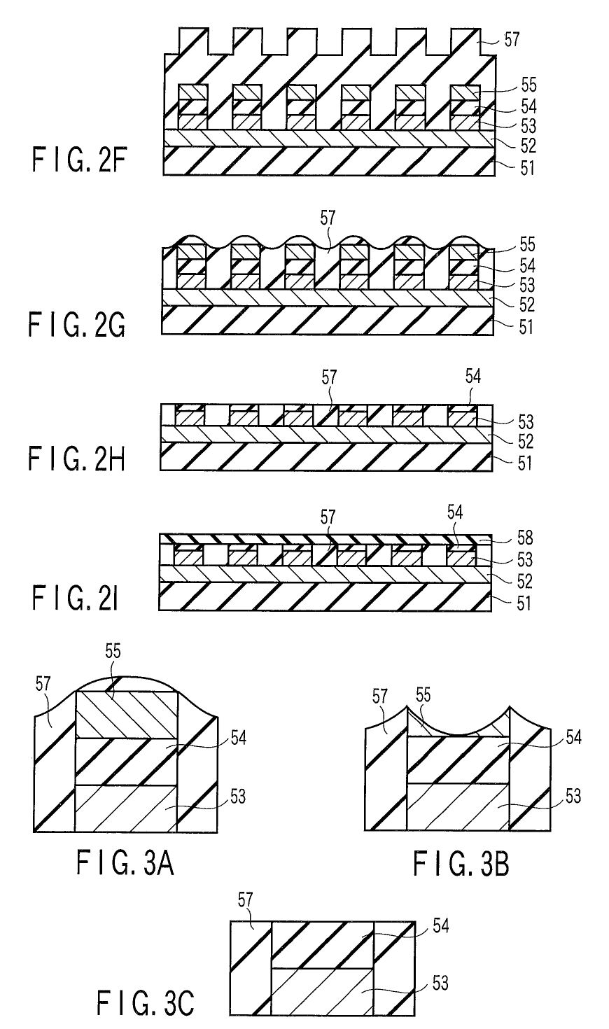

This process will be explained in more detail with reference to FIGS. 3A to 3C. FIG. 3A shows the state that the surface of the sacrifice layer 55 is exposed from the nonmagnetic material 57. When etch-back is further continued, side etching of the protruded sacrifice patterns proceeds faster because the sacrifice layer 55 has a higher etching rate than the nonmagnetic material 57. At this time, areas where the surface irregularities are inverted temporarily occur (FIG. 3B). However, when etch-back is further continued, the DLC protective layer 54 having a low etching rate, which is formed under the sacrifice layer 55, functions as an etching stopper, so that dispersion of the flattening can be suppressed (FIG. 3C).

When, for example, Ru is used for the sacrifice layer 55 and NiNbTi is used for the nonmagnetic material 57, the etching rate of Ru is about twice that of NiNbTi in the etch-back by normally incident ions. Thus, when the nonmagnetic material 57 is etched to the sacrifice layer 57 after etch-back is repeated until the depth of the recesses of the surface is reduced by about half the depth of the recesses before the recesses is filled, the surface can be highly flattened.

The etch-back is carried out for about 3 minutes. The end point of the etch-back is determined at the time when carbon of the protective layer 54 is detected with Q-MASS (quadrupole mass spectrometer). In the method of the embodiment, the depth to which the nonmagnetic material 57 is etched is not exactly determined, and therefore, it is difficult to control the etch-back based on the etching time. On the contrary, end point detection by means of Q-MASS or other etching end-point detector such as SIMS (secondary ion mass spectrometer) enables highly precise etch-back.

Finally, carbon (C) is deposited by CVD (chemical vapor deposition) to form the protective layer 58 (FIG. 21). A lubricant is applied to the surface of the protective layer 58 to provide a DTR medium.

Next, preferable materials to be used in the embodiments of the present invention will be described.

<Substrate>

As the substrate, for example, a glass substrate, Al-based alloy substrate, ceramic substrate, carbon substrate or Si single crystal substrate having an oxide surface may be used. As the glass substrate, amorphous glass or crystallized glass is used. Examples of the amorphous glass include common soda lime glass and aluminosilicate glass. Examples of the crystallized glass include lithium-based crystallized glass. Examples of the ceramic substrate include common aluminum oxide, aluminum nitride or a sintered body containing silicon nitride as a major component and fiber-reinforced materials of these materials. As the substrate, those having a NiP layer on the above metal substrates or nonmetal substrates formed by plating or sputtering may be used.

<Soft Magnetic Underlayer>

The soft magnetic underlayer (SUL) serves a part of such a function of a magnetic head as to pass a recording magnetic field from a single-pole head for magnetizing a perpendicular magnetic recording layer in a horizontal direction and to circulate the magnetic field to the side of the magnetic head, and applies a sharp and sufficient perpendicular magnetic field to the recording layer, thereby improving read/write efficiency. For the soft magnetic underlayer, a material containing Fe, Ni or Co may be used. Examples of such a material may include FeCo-based alloys such as FeCo and FeCoV, FeNi-based alloys such as FeNi, FeNiMo, FeNiCr and FeNiSi, FeAl-based alloys and FeSi-based alloys such as FeAl, FeAlSi, FeAlSiCr, FeAlSiTiRu and FeAlO, FeTa-based alloys such as FeTa, FeTaC and FeTaN and FeZr-based alloys such as FeZrN. Materials having a microcrystalline structure such as FeAlO, FeMgO, FeTaN and FeZrN containing Fe in an amount of 60 at % or more or a granular structure in which fine crystal grains are dispersed in a matrix may also be used. As other materials to be used for the soft magnetic underlayer, Co alloys containing Co and at least one of Zr, Hf, Nb, Ta, Ti and Y may also be used. The Co alloy preferably contains 80 at % or more of Co. In the case of such a Co alloy, an amorphous layer is easily formed when it is deposited by sputtering. Because the amorphous soft magnetic material is not provided with crystalline anisotropy, crystal defects and grain boundaries, it exhibits excellent soft magnetism and is capable of reducing medium noise. Preferable examples of the amorphous soft magnetic material may include CoZr-, CoZrNb- and CoZrTa-based alloys.

An underlayer may be further formed beneath the soft magnetic underlayer to improve the crystallinity of the soft magnetic underlayer or to improve the adhesion of the soft magnetic underlayer to the substrate. As the material of such an underlayer, Ti, Ta, W, Cr, Pt, alloys containing these metals or oxides or nitrides of these metals may be used. An intermediate layer made of a nonmagnetic material may be formed between the soft magnetic underlayer and the recording layer. The intermediate layer has two functions including the function to cut the exchange coupling interaction between the soft magnetic underlayer and the recording layer and the function to control the crystallinity of the recording layer. As the material for the intermediate layer Ru, Pt, Pd, W, Ti, Ta, Cr, Si, alloys containing these metals or oxides or nitrides of these metals may be used.

In order to prevent spike noise, the soft magnetic underlayer may be divided into plural layers and Ru layers with a thickness of 0.5 to 1.5 nm are interposed therebetween to attain anti-ferromagnetic coupling. Also, a soft magnetic layer may be exchange-coupled with a hard magnetic film such as CoCrPt, SmCo or FePt having longitudinal anisotropy or a pinning layer of an anti-ferromagnetic material such as IrMn and PtMn. A magnetic film (such as Co) and a nonmagnetic film (such as Pt) may be provided under and on the Ru layer to control exchange coupling force.

<Magnetic Recording Layer>

For the perpendicular magnetic recording layer, a material containing Co as a major component, at least Pt and further an oxide is preferably used. The perpendicular magnetic recording layer may contain Cr if needed. As the oxide, silicon oxide or titanium oxide is particularly preferable. The perpendicular magnetic recording layer preferably has a structure in which magnetic grains, i.e., crystal grains having magnetism, are dispersed in the layer. The magnetic grains preferably have a columnar structure which penetrates the perpendicular magnetic recording layer in the thickness direction. The formation of such a structure improves the orientation and crystallinity of the magnetic grains of the perpendicular magnetic recording layer, with the result that a signal noise ratio (SN ratio) suitable to high-density recording can be provided. The amount of the oxide to be contained is important to obtain such a structure.

The content of the oxide in the perpendicular magnetic recording layer is preferably 3 mol % or more and 12 mol % or less and more preferably 5 mol % or more and 10 mol % or less based on the total amount of Co, Cr and Pt. The reason why the content of the oxide in the perpendicular magnetic recording layer is preferably in the above range is that, when the perpendicular magnetic recording layer is formed, the oxide precipitates around the magnetic grains, and can separate fine magnetic grains. If the oxide content exceeds the above range, the oxide remains in the magnetic grains and damages the orientation and crystallinity of the magnetic grains. Moreover, the oxide precipitates on the upper and lower parts of the magnetic grains, with an undesirable result that the columnar structure, in which the magnetic grains penetrate the perpendicular magnetic recording layer in the thickness direction, is not formed. The oxide content less than the above range is undesirable because the fine magnetic grains are insufficiently separated, resulting in increased noise when information is reproduced, and therefore, a signal noise ratio (SN ratio) suitable to high-density recording is not provided.

The content of Cr in the perpendicular magnetic recording layer is preferably 0 at % or more and 16 at % or less and more preferably 10 at % or more and 14 at % or less. The reason why the content of the Cr in the perpendicular magnetic recording layer is preferably in the above range is that the uniaxial crystal magnetic anisotropic constant Ku of the magnetic grains is not too much reduced and high magnetization is retained, with the result that read/write characteristics suitable to high-density recording and sufficient thermal fluctuation characteristics are provided. The Cr content exceeding the above range is undesirable because Ku of the magnetic grains is lowered, and therefore, the thermal fluctuation characteristics are deteriorated, and also, the crystallinity and orientation of the magnetic grains are impaired, resulting in deterioration in read/write characteristics.

The content of Pt in the perpendicular magnetic recording layer is preferably 10 at % or more and 25 at % or less. The reason why the content of Pt in the perpendicular magnetic recording layer is preferably in the above range is that the Ku value required for the perpendicular magnetic layer is provided, and further, the crystallinity and orientation of the magnetic grains are improved, with the result that the thermal fluctuation characteristics and read/write characteristics suitable to high-density recording are provided. The Pt content exceeding the above range is undesirable because a layer having a fcc structure is formed in the magnetic grains and there is a risk that the crystallinity and orientation are impaired. The Pt content less than the above range is undesirable because a Ku value satisfactory for the thermal fluctuation characteristics suitable to high-density recording is not provided.

The perpendicular magnetic recording layer may contain one or more types of elements selected from B, Ta, Mo, Cu, Nd, W, Nb, Sm, Tb, Ru and Re besides Co, Cr, Pt and the oxides. When the above elements are contained, fine magnetic grains is promoted or the crystallinity and orientation can be improved and read/write characteristics and thermal fluctuation characteristics suitable to high-density recording can be provided. The total content of the above elements is preferably 8 at % or less. The content exceeding 8 at % is undesirable because phases other than the hcp phase are formed in the magnetic grains and the crystallinity and orientation of the magnetic grains are disturbed, with the result that read/write characteristics and thermal fluctuation characteristics suitable to high-density recording are not provided.

As the perpendicular magnetic recording layer, a CoPt-based alloy, CoCr-based alloy, CoPtCr-based alloy, CoPtO, CoPtCrO, CoPtSi, CoPtCrSi, a multilayer structure of an alloy layer containing at least one type selected from the group consisting of Pt, Pd, Rh and Ru and a Co layer, and materials obtained by adding Cr, B or O to these layers, for example, CoCr/PtCr, CoB/PdB and CoO/RhO may be used.

The thickness of the perpendicular magnetic recording layer is preferably 5 to 60 nm and more preferably 10 to 40 nm. When the thickness is in this range, a magnetic recording apparatus suitable to higher recording density can be manufactured. If the thickness of the perpendicular magnetic recording layer is less than 5 nm, the read output is too low and a noise component tend to be higher. If the thickness of the perpendicular magnetic recording layer exceeds 40 nm, the read output is too high and the waveform tends to be distorted. The coercivity of the perpendicular magnetic recording layer is preferably 237000 A/m (3000 Oe) or more. When the coercivity is less than 237000 A/m (3000 Oe), thermal fluctuation resistance tends to be deteriorated. The perpendicular squareness of the perpendicular magnetic recording layer is preferably 0.8 or more. If the perpendicular squareness is less than 0.8, the thermal fluctuation resistance tends to be deteriorated.

<Protective Layer>

The protective layer is provided for the purpose of preventing the corrosion of the perpendicular magnetic recording layer and also preventing the surface of a medium from being damaged when the magnetic head is brought into contact with the medium. Examples of the material of the protective layer include those containing C, SiO₂ or ZrO₂. The thickness of the protective layer is preferably 1 to 10 nm. This is preferable for high-density recording because the distance between the head and the medium can be reduced. Carbon may be classified into sp²-bonded carbon (graphite) and sp³-bonded carbon (diamond). Though sp³-bonded carbon is superior in durability and corrosion resistance to graphite, it is inferior in surface smoothness to graphite because it is crystalline material. Usually, carbon is deposited by sputtering using a graphite target. In this method, amorphous carbon in which sp²-bonded carbon and sp³-bonded carbon are mixed is formed. Carbon in which the ratio of sp³-bonded carbon is larger is called diamond-like carbon (DLC). This carbon is superior in durability and corrosion resistance and also in surface smoothness because it is amorphous and therefore utilized as the surface protective layer of the magnetic recording medium. The deposition of DLC by CVD (chemical vapor deposition) produces DLC through excitation and decomposition of raw gas in plasma and chemical reactions, and therefore, DLC richer in sp³-bonded carbon can be formed by controlling the conditions.

Next, preferred manufacturing conditions in each step in the embodiments of the present invention will be described.

<Imprinting>

A resist is applied to the surface of a substrate by spin-coating and then, a stamper is pressed against the resist to thereby transfer the patterns of the stamper to the resist. As the resist, for example, a general novolak-type photoresist or spin-on-glass (SOG) may be used. The surface of the stamper on which patterns of protrusions and recesses corresponding to servo information and recording tracks are formed is made to face the resist. In this process, the stamper, the substrate and a buffer layer are placed on the lower plate of a die set and are sandwiched between the lower plate and the upper plate of the die set to press under a pressure of 2000 bar for 60 seconds, for example. The height of the protrusions of the patterns formed on the resist by imprinting is, for instance, 60 to 70 nm. The above conditions are kept for about 60 seconds to thereby move the resist to be excluded. In this case, if a fluorine-containing peeling agent is applied to the stamper, the stamper can be peeled from the resist satisfactorily.

<Removal of Resist Residues>

Resist residues left unremoved on the bottoms of the recesses of the resist are removed by RIE (reactive ion etching). In this process, an appropriate process gas corresponding to the material of the resist is used. As the plasma source, though ICP (inductively coupled plasma) apparatus capable of producing high-density plasma under a low pressure is preferable, an ECR (electron cyclotron resonance) plasma or general parallel-plate RIE apparatus may be used.

<Etching of Magnetic Recording Layer>

After the resist residues are removed, the magnetic recording layer is processed using the resist patterns as etching masks. For the processing of the magnetic recording layer, etching using Ar ion beams (Ar ion milling) is preferable. The processing may be carried out by RIE using Cl gas or a mixture gas of CO and NH₃. In the case of RIE using the mixture gas of CO and NH₃, a hard mask made of Ti, Ta or W is used as an etching mask. When RIE is used, a taper is scarcely formed on the side walls of the protruded magnetic patterns. In processing the magnetic recording layer by Ar ion milling capable of etching any material, if etching is carried out under the conditions that, for example, the acceleration voltage is set to 400 V and incident angle of ions is varied between 30° and 70°, a taper is scarcely formed on the side walls of the protruded magnetic patterns. In milling using an ECR ion gun, if etching is carried out under static opposition arrangement (incident angle of ions is 90°), a taper is scarcely formed on the side walls of the protruded magnetic patterns.

<Stripping of Resist>

After the magnetic recording layer is etched, the resist is stripped off. When a general photoresist is used as the resist, it can be easily stripped off by oxygen plasma treatment. Specifically, the photoresist is stripped off by using an oxygen ashing apparatus under the conditions that the chamber pressure is 1 Torr, power is 400 W and processing time is 5 minutes. When SOG is used as the resist, SOG is stripped off by RIE using fluorine-containing gas. As the fluorine-containing gas, CF₄ or SF₆ is suitable. Note that, it is preferable to carry out rinsing with water because the fluorine-containing gas reacts with moisture in the atmosphere to produce an acid such as HF and H₂SO₄.

<Etch-Back of Nonmagnetic Material>

Etch-back of the nonmagnetic material is carried out until the magnetic recording layer (or the carbon protective film on the magnetic recording layer) is exposed. This etch-back process is preferably carried out by Ar ion milling or etching with an ECR ion gun.

<Deposition of Protective Layer and Post-Treatment>

After etch-back, a carbon protective layer is deposited. The carbon protective layer may be deposited by CVD, sputtering or vacuum evaporation. A DLC film containing a large amount of sp³-bonded carbon is formed by CVD. The carbon protective layer with a thickness less than 2 nm is not preferable because it results in unsatisfactory coverage. Whereas, a carbon protective layer with a thickness exceeding 10 nm is not preferable because it increases magnetic spacing between the read/write head and a medium, leading to a reduction in SNR. A lubricant is applied to the surface of the protective layer. As the lubricant, for example, a perfluoropolyether, fluorinated alcohol, fluorinated carboxylic acid or the like is used.

### EXAMPLES

### Example 1

A stamper having patterns of protrusions and recesses including servo patterns (preamble, address and burst sections) and recording tracks was used to manufacture a DTR medium by the method shown in FIGS. 2A to 2I. Ru was used for a sacrifice layer 55 and NiNbTi was used for a nonmagnetic material 57. The thickness of the sacrifice layer (Ru) was set to 5 nm. In FIG. 2F, a NiNbTi film with a thickness of 50 nm was deposited by DC sputtering under the following conditions: the Ar flow rate was 100 sccm and the chamber pressure was 0.52 Pa. In FIG. 2G, an ECR ion gun was used, the microwave power and the acceleration voltage were set to 800 W and 500 V, respectively, and Ar ions were irradiated for 3 minutes to carry out etch-back. The processes of FIGS. 2F and 2G were repeated one more time (the number of repetitions of the deposition and etch-back of the nonmagnetic material was two times). In FIG. 2H, etch-back of layers including the sacrifice layer 55 was carried out to flatten the surface. Then, 4 nm-thick DLC was deposited by CVD to form the protective layer 58, thereby manufacturing a DTR medium.

For the above DTR medium, an intermediate track region was observed with a sectional TEM (transmission electron microscope). As a result, it was confirmed that the surface was almost flattened though fine recesses about 4 nm in depth remained on the surface. The surface roughness of an address section with a wide protrusion (width of a protrusion is about 700 nm) on the outer peripheral side was observed by AFM (atomic force microscope). As a result, it was confirmed that Rmax was about 4 nm, showing the surface was satisfactorily flattened even in areas having protrusions with a large width. Read signals were observed with a spin stand. As a result, no dispersion of signal strength was found.

### Comparative Example 1

A DTR medium was manufactured in the same manner as in Example 1 except that the sacrifice layer was not deposited. For the DTR medium, an intermediate track region was observed with a sectional TEM (transmission electron microscope). As a result, it was confirmed that the surface was almost flattened though fine recesses about 4 nm in depth remained on the surface. However, when the surface roughness of an address section with a wide protrusion (width of a protrusion is about 700 nm) on the outer peripheral side was observed by AFM (atomic force microscope), it was found that Rmax was about 10 nm. Also, when read signals were observed with a spin stand, it was found that that the signal strength is lower in the outer peripheral side than in the inner peripheral side, showing that the surface of the outer peripheral side was not flattened. The DTR medium in such a state cannot be used in HDDs. Therefore, in the case of using no sacrifice layer, it is necessary to more increase the number of repetitions of deposition and etch-back of the nonmagnetic material.

### Example 2

DTR mediums were manufactured in the same manner as in Example 1 except that the thickness of the sacrifice layer was set to 10 nm, 20 nm or 30 nm. For each DTR medium, an intermediate track region was observed with a sectional TEM (transmission electron microscope). The surface of the medium manufactured using the sacrifice layer with a thickness of 10 nm was very flat. It was confirmed that the surface of the medium manufactured using the sacrifice layer with a thickness of 20 nm was almost flattened though fine recesses about 4 nm in depth remained on the surface. In the case of the medium manufactured using the sacrifice layer with a thickness of 30 nm, recesses about 13 nm in depth remained on the surface.

Taking the flying characteristics of the magnetic head into account, the depth of the recesses on the surface is preferably 5 nm or less and it is therefore preferable to use a sacrifice layer with a thickness of 20 nm or less.

### Example 3

A DTR medium was manufactured in the same manner as in Example 1 except that SiO₂ was used for the sacrifice layer. For the DTR medium, an intermediate track region was observed with a sectional TEM (transmission electron microscope). As a result, it was confirmed that the surface was almost flattened though fine recesses about 4 nm in depth remained on the surface.

The surface of the medium was observed in light-shielded test. As a result, it was observed many dusts compared with the medium of Example 1. When a nonmetal material is used, arcing easily arises in deposition of the sacrifice layer, leading to a cause of dust generation. Therefore, it is preferable to use a metal material for the sacrifice layer.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of manufacturing a magnetic recording medium, comprising:
depositing a magnetic recording layer and a sacrifice layer on a substrate;
patterning the sacrifice layer and magnetic recording layer to form protruded magnetic patterns and sacrifice patterns;
depositing a nonmagnetic material in recesses between the magnetic patterns and sacrifice patterns and on the sacrifice patterns; and
etching back the nonmagnetic material.

2. The method of claim 1, wherein the sacrifice layer has a higher etching rate than the nonmagnetic material.

3. The method of claim 1, wherein the sacrifice layer is formed of a metal.

4. The method of claim 3, wherein the metal is selected from the group consisting of Ru, Ni, Al, W, Cr, Cu, Pt and Pd.

5. The method of claim 1, wherein the sacrifice layer has a thickness of 3 nm or more and 20 nm or less.

6. The method of claim 1, wherein the deposition of the nonmagnetic material and the etch-back of the nonmagnetic material are repeated two or more times.
